(19) United States
(12) Patent Application Publication
(10) Pub. No.: US 2024/0316947 A1
(43) Pub. Date: Sep. 26, 2024

(54) PRINTER, STORAGE MEDIUM STORING COMPUTER PROGRAM, AND METHOD OF USING PRINTER

(71) Applicant: BROTHER KOGYO KABUSHIKI KAISHA, Nagoya (JP)

(72) Inventors: Tatsuya MIYASAKA, Nagoya (JP); Hiroya OKUWA, Kariya (JP); Kazunari MATSUURA, Komaki (JP); Shuhei SUZUKI, Nagoya (JP); Taiki TANAKA, Yokkaichi (JP)

(21) Appl. No.: 18/588,424

(22) Filed: Feb. 27, 2024

(30) Foreign Application Priority Data
Mar. 23, 2023 (JP) 2023-047028

(51) Int. Cl. B41J 2/205; B41J 2/045; B41J 2/21

(52) U.S. Cl. CPC B41J 2/2056; B41J 2/04541; B41J 2/2132

(57) ABSTRACT

A printer includes an ejection head and a controller. The ejection head includes a nozzle configured to eject sublimation ink to a transfer sheet. The controller is configured to acquire an inspection image indicating transfer unevenness. The transfer unevenness is generated when an image on the transfer sheet is transferred to a recording medium by heat press. The controller is configured to change an image to be formed on the transfer sheet based on the inspection image.

### REFERENCE TO RELATED APPLICATIONS

This application claims priority from Japanese Patent Application No. 2023-047028 filed on Mar. 23, 2023. The entire content of the priority application is incorporated herein by reference.

### BACKGROUND ART

As one of a plurality of categories of printing machines, a sublimation transfer printing machine is known.

### SUMMARY

In general, a process of manufacturing a recording medium on which an image is formed with a sublimation ink includes a plurality of steps as follows. That is, the process includes a step of forming an image on a transfer sheet by ejecting a sublimation ink by a sublimation printer, and a step of transferring the image to a recording medium by heating the transfer sheet having the image using a heat press machine in a state where the transfer sheet is overlaid on the recording medium.

Thus, the quality of the image transferred to the recording medium is also affected by a heating result by the heat press machine. For example, a press surface of the heat press machine is adjusted to a particular temperature by heat generation of an internal heat source, but the temperature distribution in the surface is not necessarily uniform, and temperature unevenness may partially occur. If the press surface has temperature unevenness, the progress of sublimation (transfer) of sublimation ink from the transfer sheet varies partially, which affects the quality of the image.

However, there is room for improvement in suppression of deterioration of image quality when temperature unevenness occurs on the press surface of the heat press.

In view of the foregoing, an example of an object of this disclosure is to provide a sublimation printer configured to suppress deterioration in quality of an image transferred to a recording medium even when temperature unevenness occurs on a press surface of a heat press, a storage medium storing a computer program, and a method of using a printer.

According to one aspect, this specification discloses a printer. The printer includes an ejection head and a controller. The ejection head includes a nozzle configured to eject sublimation ink to a transfer sheet. The controller is configured to perform acquiring an inspection image indicating transfer unevenness, the transfer unevenness being generated when an image on the transfer sheet is transferred to a recording medium by heat press. Thus, the printer acquires the inspection image indicating transfer unevenness. The controller is configured to perform changing an image to be formed on the transfer sheet based on the inspection image. Thus, the printer changes the image to be formed on the transfer sheet based on the inspection image.

According to another aspect, this specification also discloses a non-transitory computer-readable storage medium storing a set of program instructions for a printer including a controller and an ejection head including a nozzle configured to eject sublimation ink to a transfer sheet. The set of program instructions, when executed by the controller, causes the printer to perform: acquiring an inspection image indicating transfer unevenness, the transfer unevenness being generated when an image on the transfer sheet is transferred to a recording medium by heat press; and changing an image to be formed on the transfer sheet based on the inspection image.

According to still another aspect, this specification also discloses a method of using a printer including an ejection head including a nozzle configured to eject sublimation ink to a transfer sheet. The method includes: forming a particular pattern image by ejecting sublimation ink to the transfer sheet; and receiving a change setting of changing an image to be formed on the transfer sheet, based on comparison between a particular color sample and either the transfer sheet having sublimation ink remaining after the pattern image on the transfer sheet is transferred to a recording medium by heat press or the recording medium having the transferred pattern image.

With this configuration, since the image (for example, density thereof) to be formed on the transfer sheet is changed based on transfer unevenness corresponding to temperature unevenness on the press surface of the heat press, the influence of the temperature unevenness on the image quality is reduced.

According to the present disclosure, even when temperature unevenness occurs on the press surface of the heat press, deterioration in quality of the image transferred to the recording medium is suppressed.

### BRIEF DESCRIPTION OF DRAWINGS

FIG. 1 is an external view showing a configuration of a printer.

FIG. 2 is a block diagram showing a functional configuration of the printer.

FIG. 3 is a flowchart showing an example of operations of the printer in an image quality improvement process.

FIGS. 4A, 4B and 4C are schematic diagrams showing examples of pattern images for inspection.

FIG. 5 is a flowchart showing an example of operations of a printer in an image quality improvement process.

FIG. 6 is a flowchart showing an example of operations of a printer in an image quality improvement process.

FIG. 7 is a flowchart showing an example of operations (example of use) of a printer in an image quality improvement process.

FIG. 8 is a flowchart showing an example of operations of a printer in an image quality improvement process.

### DESCRIPTION

Hereinafter, embodiments according to the present disclosure will be described with reference to the drawings. In the following description, the same or corresponding elements are denoted by the same reference numerals throughout the drawings, and redundant description thereof will be omitted. The present disclosure is not limited to the following embodiments, and additions, deletions, and modifications may be made without departing from the spirit of the present disclosure.

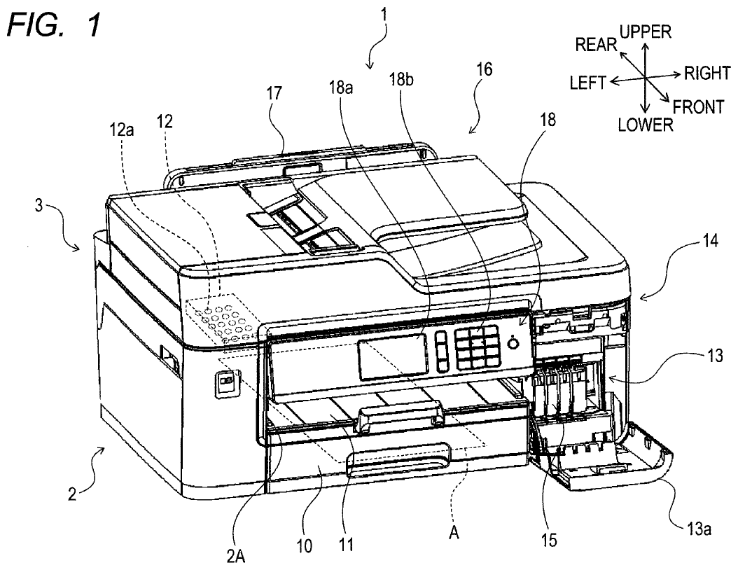

FIG. 1 is an external view showing a configuration of a sublimation printer 1 according to an embodiment. In the embodiment, a front-rear direction, a left-right direction, and an upper-lower direction are defined as shown in FIG. 1, based on a state where the printer 1 is installed in a usable state. The printer 1 has a printer function and a scanner function, and includes a lower housing 2, an upper housing 3, and so on.

The lower housing 2 has a substantially rectangular parallelepiped shape and has an opening 2A at the front. A feed tray 10, a discharge tray 11, an ejection head 12, a cartridge mount portion 13, a scanner unit 14, and so on are provided inside the lower housing 2. The feed tray 10 is formed in a flat tray shape, accommodates a plurality of transfer sheets A having a particular size. The feed tray 10 is accommodated in a lower portion of the lower housing 2 so as to be attachable from and detachable to the front. The discharge tray 11 is formed in a flat plate shape, is disposed above the feed tray 10, and extends rearward from below the opening 2A.

The ejection head 12 has a plurality of nozzles 12a for ejecting sublimation ink. Thus, by ejecting sublimation ink from the nozzles 12a of the ejection head 12, an image is formed on the transfer sheet A. A cover 13a configured to open and close is provided on a front side of the lower housing 2, and the cartridge mount portion 13 is formed behind the cover 13a. The cartridge mount portion 13 (an example of an ink container mount portion) has a space for accommodating a plurality of cartridges 15 (an example of a plurality of ink containers) storing sublimation ink, and the cartridges 15 are attachable to and detachable from the space.

When the cartridge 15 is mounted on the cartridge mount portion 13, sublimation ink in the cartridge 15 is sent to the ejection head 12 via a supply tube. The ejection head 12 shown in FIG. 1 is a serial head, and ejects sublimation ink from the nozzles 12a while reciprocating in the left-right direction. The printer 1 of FIG. 1 ejects sublimation ink of a plurality of different colors. Thus, the four cartridges 15 corresponding to four colors of ink, that is, cyan, magenta, yellow, and black, are mounted on the cartridge mount portion 13. Although a serial head is shown in FIG. 1, the present disclosure is not limited thereto, and a so-called line head may be employed as the ejection head of the printer 1.

The scanner unit 14 is provided at an upper portion of the lower housing 2. The scanner unit 14 is, for example, a flatbed type, and includes a glass document table forming a top surface of the lower housing 2, an image sensor, and an optical system. The scanner unit 14 scans a document placed on the document table and reads an image on the document.

The upper housing 3 is a substantially rectangular parallelepiped housing having substantially the same size in the front-rear and left-right directions as the upper surface of the lower housing 2. The upper housing 3 is provided so as to cover the upper surface of the lower housing 2. The lower housing 2 and the upper housing 3 are connected at their rear ends, and are configured to be opened by rotating the front portion of the upper housing 3 so as to separate the same upward from the front portion of the lower housing 2.

The upper housing 3 is provided with an automatic document feeder (ADF) 16. When one or more sheets are set on the ADF 16, one of the sheets is conveyed onto the document table of the scanner unit 14.

As shown in FIG. 1, the printer 1 also includes a rear feed tray 17 at the rear of the lower housing 2 and the upper housing 3. Thus, the printer 1 also forms an image by feeding the transfer sheet A from the rear feed tray 17 instead of the feed tray 10 and ejecting sublimation ink from the ejection head 12 onto the transfer sheet A.

An operation panel 18 is provided at the front of the lower housing 2. The operation panel 18 is an input interface for inputting various information or instructions by a user, and is also an output interface for outputting various information to the user. Thus, the operation panel 18 includes a touch panel type display 18a, physical buttons 18b such as a numeric keypad, and so on.

The printer 1 includes, for example, a conveyance device and a scanning device in addition to the above-described configuration. Although a detailed description is omitted, the conveyance device conveys the transfer sheet A from the feed tray 10 or the rear feed tray 17 to the discharge tray 11 through a portion below the ejection head 12 in the lower housing 2. The scanning device moves (scans) the ejection head 12 in the left-right direction.

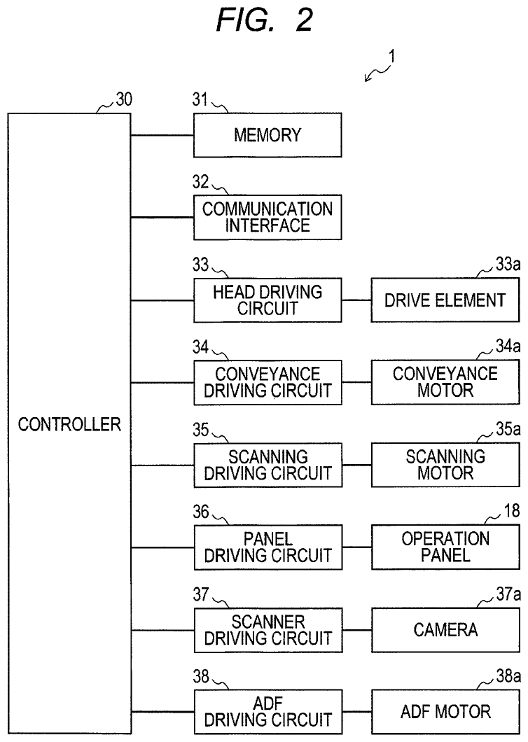

FIG. 2 is a block diagram showing a functional configuration of the printer 1. As shown in FIG. 2, the printer 1 includes a controller 30 as well as a memory 31, a communication interface 32, a head driving circuit 33, a conveyance driving circuit 34, a scanning driving circuit 35, a panel driving circuit 36, a scanner driving circuit 37, and an ADF driving circuit 38 each connected to the controller 30.

The controller 30 is, for example, a computer, and includes a processor such as an MPU or a circuit including an integrated circuit such as an ASIC. The memory 31 is a memory accessible from the controller 30, and includes, for example, a RAM and a ROM. The RAM temporarily stores image data relating to an image to be printed, image data acquired by the scanner unit 14, and various kinds of data used in calculation by the controller 30. The ROM stores a computer program for performing various data processing and data. Thus, the controller 30 controls the operation of each part of the printer 1 by executing the computer program while referring to the date stored in the memory 31.

The communication interface 32 is a connection device that connects the controller 30 to an external device of the printer 1. Examples of the external device include another computer, a communication network, a storage medium, a display, and another printing apparatus. The printer 1 acquires various kinds of information including image data from an external device such as a computer via the communication interface 32.

The head driving circuit 33 is electrically connected to drive elements 33a such as piezoelectric actuators included in the ejection head 12, and controls the operation of the drive elements 33a. That is, the controller 30 outputs a control signal for driving the drive elements 33a to the head driving circuit 33, and the head driving circuit 33 generates a driving signal based on the input control signal and outputs the driving signal to each drive element 33a. As a result, the respective drive elements 33a are driven based on the corresponding driving signals, and operate to apply particular ejection pressures to sublimation ink in the ejection head 12 at particular timings. Thus, regarding sublimation ink ejected from each nozzle 12a, the controller 30 controls the ejection timing and the size of the ink (the volume of an ink droplet).

The conveyance driving circuit 34 is electrically connected to a conveyance motor 34a included in the conveyance device provided in the lower housing 2, and the controller 30 controls the operation of the conveyance motor 34a via the conveyance driving circuit 34. Thus, the conveyance device intermittently or continuously conveys the transfer sheet A from the feed tray 10 or the rear feed tray 17 to the discharge tray 11 through the lower side of the ejection head 12.

The scanning driving circuit 35 is electrically connected to a scanning motor 35a included in the scanning device, and the controller 30 controls the operation of the scanning motor 35a via the scanning driving circuit 35. Thus, the scanning device moves a carriage supporting the ejection head 12 in the left-right direction, and stops the carriage at a desired position within the movable range.

The panel driving circuit 36 is electrically connected to the operation panel 18 described above, and the controller 30 controls the operation of the operation panel 18 via the panel driving circuit 36.

The scanner driving circuit 37 is electrically connected to a camera 37a included in the scanner unit 14 described above, and the controller 30 controls the operation of the camera 37a via the scanner driving circuit 37. Thus, the scanner unit 14 captures an image of a document placed on the document table with the camera 37a, and the acquired image data is stored in the memory 31 such as a RAM.

The ADF driving circuit 38 is electrically connected to an ADF motor 38a included in the ADF 16 described above, and the controller 30 controls the operation of the ADF motor 38a via the ADF driving circuit 38. Thus, in the ADF 16, an ADF roller connected to the ADF motor 38a is rotated to convey one or a plurality of set transfer sheets A to the document table one sheet at a time.

The printer 1 as described above forms an image on a recording medium (transfer target) such as a fabric with sublimation ink by being used together with a heat press machine. This will be described in detail. First, image data relating to an image to be formed on the recording medium is stored in the memory 31 of the printer 1. Such image data may be sent from an external device via the communication interface 32, or may be read by the scanner unit 14 of the printer 1.

Next, the printer 1 generates reversed image data relating to a reversed image acquired by reversing an image from the above-mentioned image data. The reversed image data may be generated by the printer 1 in this way, or may be acquired from an external device via the communication interface 32.

Next, when an instruction to execute printing is input by a user operating the operation panel 18 and so on, the printer 1 conveys the transfer sheet A in the feed tray 10 to a particular position below the ejection head 12 by the conveyance device, for example. Then, sublimation ink is ejected from the ejection head 12 to the transfer sheet A based on the reversed image data, and the transfer sheet A is intermittently conveyed by the conveyance device. In this way, a reversed image is formed on the transfer sheet A by sublimation ink, and the transfer sheet A is discharged to the discharge tray 11.

The reversed image formed on the transfer sheet A in this manner is transferred to a recording medium in the heat press machine. The heat press machine includes, for example, a lower support base (support table) and an upper pressing plate, and a recording medium such as a T-shirt is placed on the support base with a transfer surface facing upward. Further, the transfer sheet A is disposed to be overlaid on the transfer surface. At this time, the transfer sheet A is disposed such that the reversed image on the transfer sheet A faces the transfer surface of the recording medium. In this state, the pressing plate is lowered toward the support base.

In the heat press machine, a particular pressure is applied between the pressing plate and the support base in a state where the recording medium and the transfer sheet A are sandwiched. In addition, the support base and/or the pressing plate is provided with an electrically driven heat source therein, and the temperature is raised to a particular temperature. Thus, the recording medium and the transfer sheet A are heated and pressurized by the heat press machine. As a result, sublimation ink forming the reversed image on the transfer sheet A is sublimated and transferred to the facing recording medium.

The temperature distribution in the heating surface of the heat press machine is not necessarily uniform, and temperature unevenness may partially occur. If the heating surface has temperature unevenness, the progress of sublimation of sublimation ink from the transfer sheet varies partially, and transfer unevenness occurs, which affects the quality of an image. Thus, the printer 1 acquires transfer unevenness caused by temperature unevenness of the heating surface in advance, and changes the image to be formed on the transfer sheet based on the transfer unevenness, thereby improving the quality of the image. An image quality improvement process will be described in detail below.

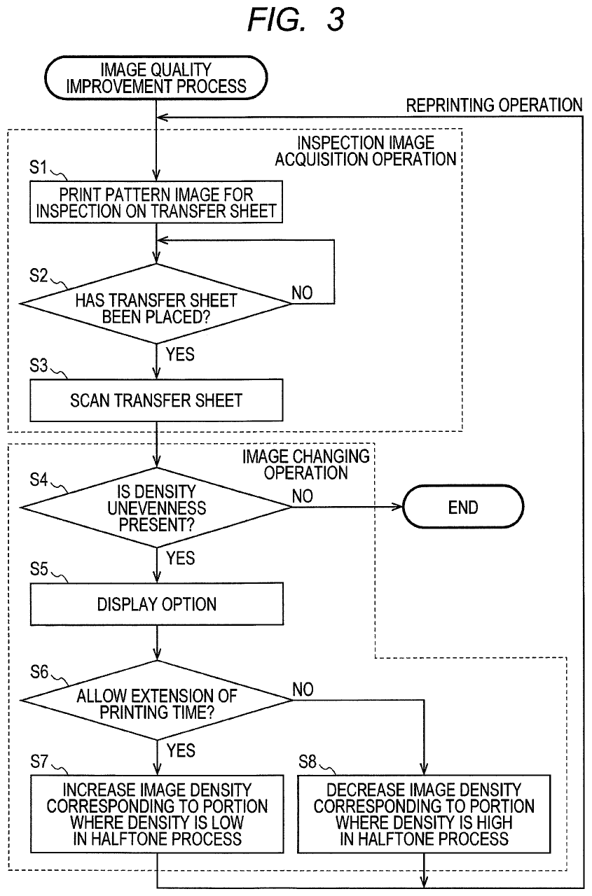

FIG. 3 is a flowchart showing an operation example of the printer 1 in an image quality improvement process according to a first embodiment. The controller 30 of the printer 1 starts the image quality improvement process based on an instruction input by the user through the operation panel 18 or an instruction input from an external device through the communication interface 32.

First, an overview is provided. The controller 30 executes an “inspection image acquisition operation” (S1 to S3) of acquiring an inspection image indicating transfer unevenness when an image on the transfer sheet A is transferred to a recording medium by the heat press machine. Next, the controller 30 executes an “image changing operation” (S4 to S8) of changing the image to be formed on the transfer sheet A based on the acquired inspection image.

The processing during each operation will be described. First, in the inspection image acquisition operation, the controller 30 controls the conveyance driving circuit 34 to convey the transfer sheet A stored in the feed tray 10, for example, and controls the head driving circuit 33 to eject sublimation ink from the ejection head 12 to print a particular pattern image 40 for inspection (S1).

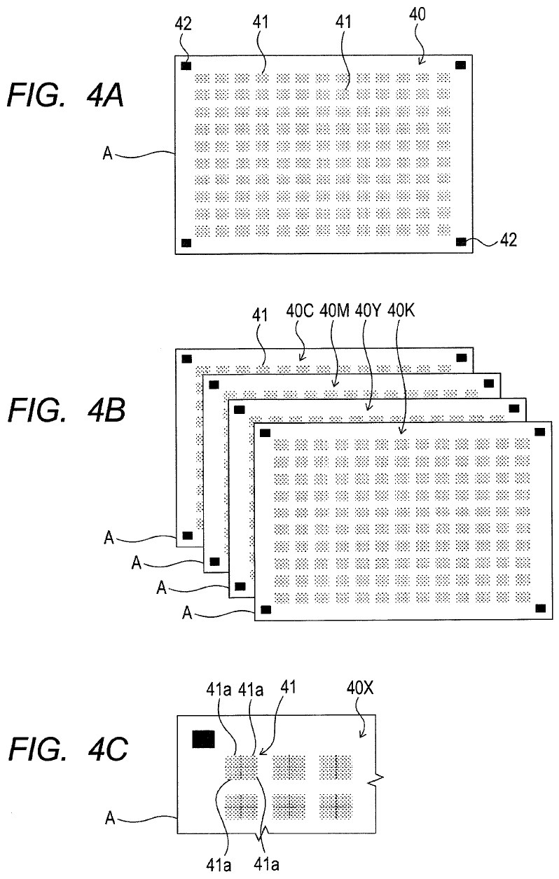

As the pattern image 40 for inspection, for example, as shown in FIG. 4A, an image in which a plurality of patch images 41 are arranged in a matrix form may be used. In FIG. 4A, each patch image 41 has a rectangular shape, but the shape of the patch image 41 is not limited thereto and may be appropriately set. The patch images 41 constituting the pattern image 40 shown in FIG. 4A are all printed with sublimation ink of the same color. Marks 42 shown at four corners of the transfer sheet A in FIG. 4A are marks for positioning.

Next, the pattern image 40 is transferred to a recording medium by using the heat press machine. Specifically, as described above, the transfer sheet A having the printed pattern image 40 and the recording medium are placed on the support base of the heat press machine in a state of being overlaid on each other, and are heated while being pressed from above by the pressing plate. In this way, sublimation ink forming the pattern image 40 on the transfer sheet A is sublimated and transferred to the recording medium.

Here, a residual pattern image formed of sublimation ink which has not been transferred remains on the transfer sheet A after transfer. The residual pattern image is a pattern image in which the density is reduced as a result of some of sublimation ink moving from the original pattern image 40 to the recording medium. If the temperature of the heating surface of the heat press machine is uniform, the residual pattern image becomes an image having uniform density. If temperature unevenness is present on the heating surface, transfer unevenness occurs, and thus, the residual pattern image becomes an image having density unevenness.

As the temperature of the heating surface of the heat press machine is higher, more sublimation ink is transferred to the transfer sheet A, and the density of the image transferred to the recording medium becomes higher, and the density of the residual pattern image remaining on the transfer sheet A becomes lower. As the temperature of the heating surface of the heat press machine is lower, less sublimation ink is transferred to the transfer sheet A, and the density of the image transferred to the recording medium becomes lower, and the density of the residual pattern image remaining on the transfer sheet A becomes higher. That is, the density of the image transferred to the recording medium and the density of the residual pattern image have the opposite magnitude relationship.

Thus, the controller 30 determines whether the transfer sheet A after transfer is placed on the document table of the scanner unit 14 by the user, for example (S2), and in response to determining that the transfer sheet A is placed, controls the scanner unit 14 to scan the transfer sheet A (S3). Thus, image data acquired by capturing the residual pattern image remaining on the transfer sheet A after transfer is acquired as an inspection image indicating transfer unevenness. The determination of S2 may be made by, for example, whether an instruction to execute scanning is input by the user via the operation panel 18. Alternatively, a sensor for detecting the leading edge of a document may be provided at the ADF, and it may be determined that the transfer sheet A after transfer is placed on the document table of the scanner unit 14 when the sensor is turned on. By reading the marks 42 when scanning the transfer sheet A, the correspondence relationship between a position where temperature unevenness is present and a position on the image is accurately acquired.

Next, in the image changing operation, the controller 30 determines whether density unevenness is present based on the inspection image (S4). For example, the controller 30 extracts a patch image having the highest density and a patch image having the lowest density from the residual pattern image which is the inspection image, and acquires a density difference between the patch images. If the density difference is greater than or equal to a particular value, the controller 30 determines that density unevenness is present (S4: YES). If the density difference is less than the particular value, the controller 30 determines that no density unevenness is present (S4: NO). However, the method of determining the presence or absence of density unevenness is not limited thereto, and other methods may be adopted.

In response to determining in S4 that no density unevenness is present, the controller 30 ends the current image quality improvement process. In response to determining in S4 that density unevenness is present, the controller 30 controls the operation panel 18 to display a particular option for the user, for example (S5). Then, the controller 30 determines whether the user has operated the operation panel 18 to input an instruction to allow extension (increase) of printing time (S6). For example, in the first embodiment, the density of the image formed on the transfer sheet A is changed in order to suppress deterioration of image quality due to density unevenness. As the density changing method, a method requiring a long printing time and a method requiring a short printing time are prepared. Thus, the controller 30 controls the operation panel 18 to display a message inquiring the user whether to allow extension of the printing time, and determines whether there is an input indicating that extension of the printing time is allowed.

As a result, when the user operates the operation panel 18 to input an instruction to allow the printing time to be extended (S6: YES), the controller 30 changes settings in a halftone process so as to increase an image density corresponding to a portion where the density is low in the image transferred to the recording medium (S7). That is, the content of the halftone process is changed such that the image density after printing is increased from the original set value for a portion on the image corresponding to a portion where the density is relatively higher than other regions in the inspection image (the residual pattern image). For example, the increasing the image density means changing color values in a Lab color space such that a value “a” and a value “b” become farther from the origin, not making a value “L” closer to black. As a result, although the printing time becomes longer than when the halftone process is executed with the original settings, density unevenness is suppressed and an image with good color development is printed.

The method of changing the halftone process for increasing the density of the printed image is not particularly limited. For example, the size of liquid droplets of sublimation ink ejected from the nozzles 12a may be increased from the original setting. Alternatively, a duty of sublimation ink ejected from the nozzles 12a may be increased from the original setting. The duty is a ratio of a total area of dots of ink in a particular section (for example, a 600 dpi×600 dpi section) to an area of the particular section. For example, when the entirety of the particular section is covered with dots, the duty is 100%. When a half of the particular section is covered with dots, the duty is 50%.

When the user operates the operation panel 18 to input an instruction not to extend the printing time (S6: NO), the controller 30 changes settings in the halftone process so as to reduce an image density corresponding to a portion where the density is high in the image transferred to the recording medium (S8). That is, the content of the halftone process is changed such that the image density after printing is decreased from the original set value for a portion on the image corresponding to a portion where the density is relatively lower than other regions in the inspection image (the residual pattern image). For example, the decreasing the image density means changing color values in a Lab color space such that a value “a” and a value “b” become closer to the origin, not making a value “L” closer to white. Thus, the density variation is suppressed, and the printing time is shortened as compared with the case where the halftone process is performed with the original setting.

The method of changing the halftone process for reducing the density of the printed image is not particularly limited. For example, the size of liquid droplets of sublimation ink ejected from the nozzles 12a may be decreased from the original setting. Alternatively, the duty of sublimation ink ejected from the nozzles 12a may be decreased from the original setting.

After changing the content of the halftone process as described above, the controller 30 moves to the processing of S1 again. That is, the controller 30 executes a reprinting operation of printing the image changed by the image changing operation by ejecting sublimation ink onto the transfer sheet A. Further, the controller 30 again executes the inspection image acquisition operation (S1 to S3) and the image changing operation (S4 to S8) based on the transfer sheet A having the image formed by the reprinting operation. For the second and subsequent image changing operations, the processes in S5 and thereafter are omitted depending on the determination result of S4.

In this way, by repeatedly executing the inspection image acquisition operation (S1 to S3) and the image changing operation (S4 to S8), the image quality is reliably improved.

Modifications of the pattern image 40 for inspection illustrated in FIG. 4A are shown in FIG. 4B and FIG. 4C. The pattern image 40 shown in FIG. 4B is printed on a plurality of different transfer sheets A for respective colors of sublimation ink. For example, a pattern image 40C is printed on one transfer sheet A with a cyan sublimation ink, and a plurality of patch images 41 of cyan color are arranged in the pattern image 40C. A pattern image 40M is printed on another transfer sheet A with a magenta sublimation ink, and a plurality of magenta patch images 41 are arranged in the pattern image 40M. A pattern image 40Y is printed on still another transfer sheet A with a yellow sublimation ink, and a plurality of patch images 41 of yellow color are arranged in the pattern image 40Y. A pattern image 40K is printed on still another transfer sheet A with black sublimation ink, and a plurality of black patch images 41 are arranged in the pattern image 40K.

In FIG. 4C, a part of the transfer sheet A is shown in an enlarged manner. A pattern image 40X shown in FIG. 4C has a configuration in which patch images 41 of a plurality of colors are arranged on one transfer sheet A. Specifically, one patch image 41 is divided into a plurality of (four in this case) small regions smaller than the patch image 41, and the small regions are printed with sublimation ink of different colors. In the example of FIG. 4C, one rectangular patch image 41 is divided into four rectangular small regions 41a, and these four small regions 41a are printed with sublimation ink of cyan, magenta, yellow, and black. The patch images 41 having this configuration are arranged in a matrix on the transfer sheet A to form the pattern image 40X, similarly to the example of FIG. 4A.

In these cases, the inspection image used in the image quality improvement process is an image acquired by capturing the transfer sheet A having sublimation ink remaining after the pattern images 40 (the pattern images 40C, 40M, 40Y, 40K, and the pattern image 40X) for the respective colors formed on the transfer sheet A are transferred to the recording medium by the heat press machine. Thus, even when the sublimation mode differs depending on the ink type (for example, color of ink), transfer unevenness caused by temperature unevenness according to the ink type is grasped, and the image quality is improved by changing the content of the halftone process for each ink type.

In the examples of FIG. 4B and FIG. 4C, sublimation ink for each color of cyan, magenta, and yellow are printed on the different transfer sheets A or the different regions. Alternatively, the patch images may be formed by ejecting sublimation ink of cyan, magenta, and yellow in the same region on the same transfer sheet A in a superimposed manner. In this case, the color of the patch image is determined by the ink ejection amount of each color, and for example, when the same amount of ink is ejected for each color, a gray patch image is typically formed. When the transfer amount by the heat press is the same for all colors, the gray density of the patch image changes, and when the transfer amount is different for each color, the density and hue of the patch image change. Thus, in S4 of the image quality improvement process, by determining the presence or absence of a relative difference in density and hue (that is, density unevenness and hue unevenness) between the plurality of patch images, temperature unevenness of the heating surface of the heat press machine is acquired.

The printer 1 according to a second embodiment is the same as that described in the first embodiment in terms of the configuration, but is different in terms of a part of the image quality improvement process. Thus, the following description will be focused on the differences from the first embodiment in the image quality improvement process.

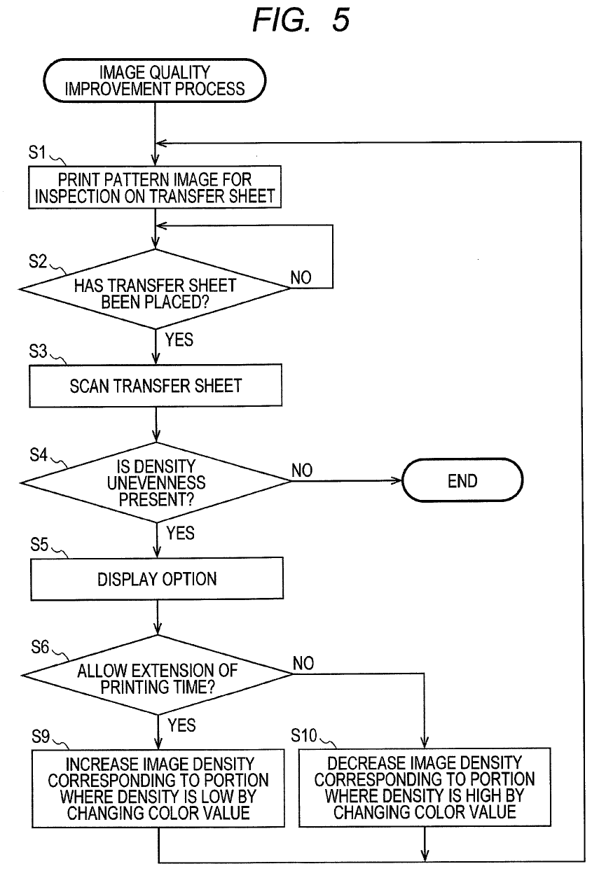

FIG. 5 is a flowchart showing an operation example of the printer 1 in the image quality improvement process according to the second embodiment. As shown in FIG. 5, the controller 30 executes the same processing of S1 to S6 as that shown in FIG. 3 in the image quality improvement process. In the image quality improvement process of FIG. 5, S9 is executed instead of S7 of FIG. 3, and S10 is executed instead of S8.

That is, in the example of FIG. 3, in response to determining that density unevenness is present (S4: YES), the controller 30 changes the content of the halftone process to change the density of the image. In the embodiment of FIG. 5, the controller 30 changes color values of image data to change the density of the image. Specifically, when the user operates the operation panel 18 to input an instruction to extend the printing time (S6: YES), regarding a portion where the density is low in an image transferred to the recording medium (that is, a portion where the density is high in the residual pattern image remaining on the transfer sheet A), the controller 30 changes the color values of image data indicating an image to be formed on the transfer sheet A such that the image becomes darker (S9).

For example, it is assumed that RBG values of 256 gradations are used as color values in which (R, G, B)=(0,0,0) represents black, and (R, G, B)=(255,255,255) represents white. In this case, in order to make the image darker in S9, the controller 30 changes the RGB values representing the color values of the image data to smaller values. The numerical value to change may be determined according to the magnitude of the density unevenness acquired in S4, or may be a preset value.

When the user operates the operation panel 18 to input an instruction not to extend the printing time (S6: NO), regarding a portion where the density is high in an image transferred to the recording medium (that is, a portion where the density is low in the residual pattern image remaining on the transfer sheet A), the controller 30 changes the color values of image data indicating an image to be formed on the transfer sheet A such that the image becomes lighter (S10). In a case where the RGB values of 256 gradations are used as the color values, in order to make the image lighter in S10, the controller 30 changes the RGB values representing the color values of the image data to larger values. The numerical value to change may be determined according to the magnitude of the density unevenness acquired in S4, or may be a preset value.

The printer 1 according to a third embodiment is the same as that described in the first embodiment in terms of the configuration, but is different in terms of a part of the contents of the image quality improvement process. Thus, the following description will be focused on the differences from the first embodiment in the image quality improvement process.

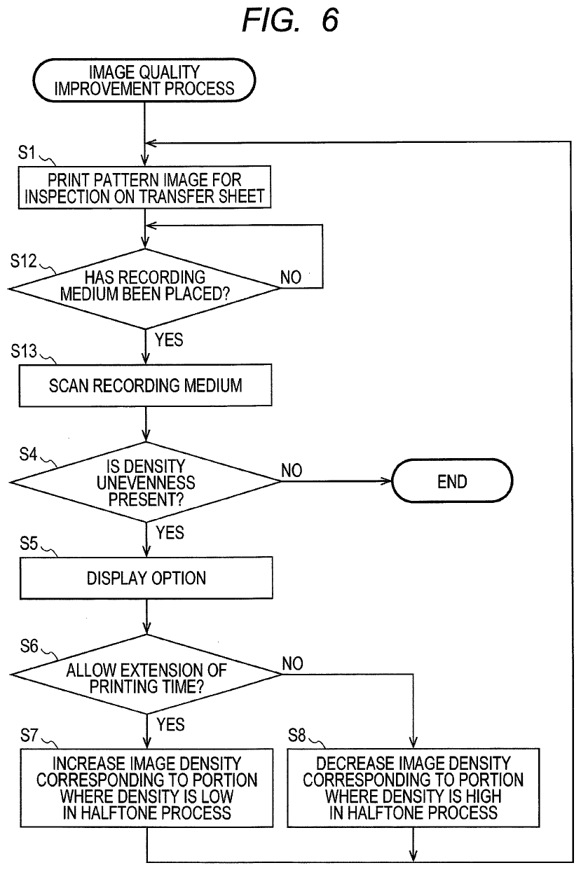

FIG. 6 is a flowchart showing an operation example of the printer 1 in the image quality improvement process according to the third embodiment. In the first embodiment, the inspection image indicating the transfer unevenness is acquired by reading the transfer sheet A after transfer by the scanner unit 14. In contrast, in the third embodiment, an image transferred onto a recording medium (hereinafter, referred to as a transferred image) is adopted as an inspection image indicating transfer unevenness. Thus, instead of S2 and S3 in the flowchart of FIG. 3 described in the first embodiment, S12 and S13 are executed in FIG. 6.

More specifically, the controller 30 determines whether a recording medium after transfer is placed on the document table of the scanner unit 14 by the user (S12), and if the recording medium is placed, controls the scanner unit 14 to scan the recording medium (S13). Thus, image data acquired by capturing the transferred image on the recording medium is acquired as an inspection image indicating transfer unevenness. The contents of the other steps in FIG. 6 are the same as those described in FIG. 3.

According to the third embodiment, transfer unevenness is detected based on the transferred image on the recording medium, and the density is adjusted. In this way, since the density is adjusted based on information directly acquired from the transferred image which is the target of image quality improvement, a further improvement of the image quality is expected.

In a fourth embodiment, a method of using the printer 1 when performing the image quality improvement process will be described. The printer 1 according to the fourth embodiment is the same as that described in the first embodiment in terms of the configuration, but is different in terms of a part of the image quality improvement process. Thus, the following description will be focused on the differences from the first embodiment in the image quality improvement process.

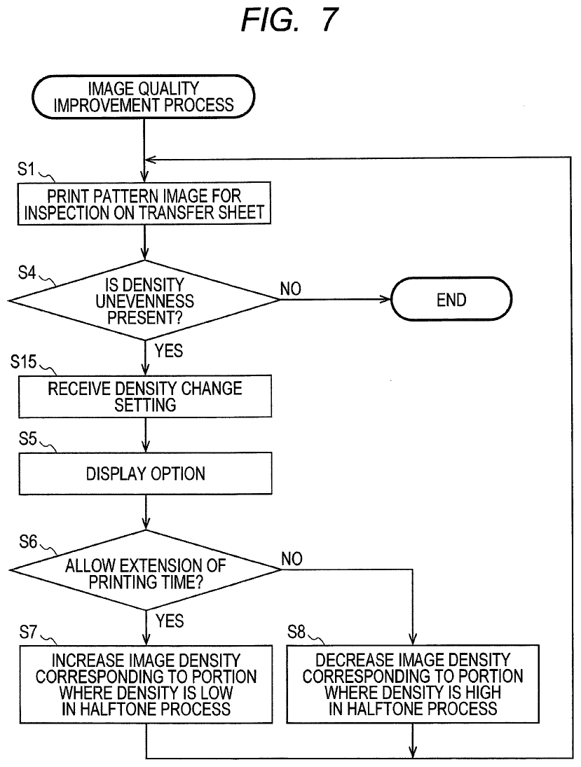

FIG. 7 is a flowchart showing an operation example (use example) of the printer 1 in the image quality improvement process according to the fourth embodiment. In the first embodiment, the controller 30 having read the pattern image 40 for inspection determines the presence or absence of the density unevenness in S4. In the fourth embodiment, the user substantially visually determines the presence or absence of density unevenness. Thus, in the image quality improvement process according to the fourth embodiment, as shown in FIG. 7, steps S2 and S3 are omitted as compared with the example of FIG. 3, and new step S15 is added between S4 and S5.

The image quality improvement process of FIG. 7 will be described in detail. In S1, the controller 30 controls the conveyance driving circuit 34 to convey the transfer sheet A stored in the feed tray 10, for example, and controls the ejection head 12 to eject sublimation ink to print the particular pattern image 40 for inspection (S1). Next, without reading the transfer sheet A after transfer by the scanner unit 14, the controller 30 waits for an input of a determination result of the presence or absence of density unevenness by the user (S4).

In S4, in response to receiving an input indicating that no density unevenness is present by an operation of the operation panel 18 by the user (S4: NO), the controller 30 ends the image quality improvement process. In response to receiving an input indicating that density unevenness is present (S4: YES), the controller 30 receives a user's input regarding a density change setting (S15).

That is, in S15, the controller 30 receives a user's input of change setting for changing the image to be formed on the transfer sheet based on comparison between the transfer sheet A having sublimation ink remaining after the pattern image 40 on the transfer sheet A is transferred to the recording medium by the heat press machine and a particular color sample. Alternatively, in S15, the controller 30 receives a user's input of changing setting based on comparison between the recording medium having the transferred pattern image 40 and a color sample. For example, the user may input, via the operation panel 18, information indicating the density difference between a patch image having the highest density and a patch image having the lowest density. The information indicating the density difference corresponds to a change value for changing the density of the image, and is designated by, for example, a numerical value.

Next, as a particular option for the user, for example, the controller 30 controls the operation panel 18 to display a message inquiring whether to allow extension of the printing time (S5).

When the user operates the operation panel 18 to input an instruction to allow the printing time to be extended (S6: YES), the controller 30 changes the setting in the halftone process so as to increase the image density corresponding to a portion where the density is low in an image transferred to the recording medium (S7). When the user inputs an instruction to not allow extension of the printing time (S6: NO), the controller 30 changes the setting in the halftone process so as to decrease the image density corresponding to a portion where the density is high in an image transferred to the recording medium (S8). Here, the amount of change to increase or decrease the image density is determined based on input information by the user in S15.

According to the fourth embodiment, density adjustment according to the user's sense is performed. This enables improvement in image quality of a transferred image which is closer to the user's sense.

The printer 1 according to a fifth embodiment is the same as that described in the first embodiment in terms of the configuration, but is different in terms of a part of the image quality improvement process. Thus, the following description will be focused on the differences from the first embodiment in the image quality improvement process.

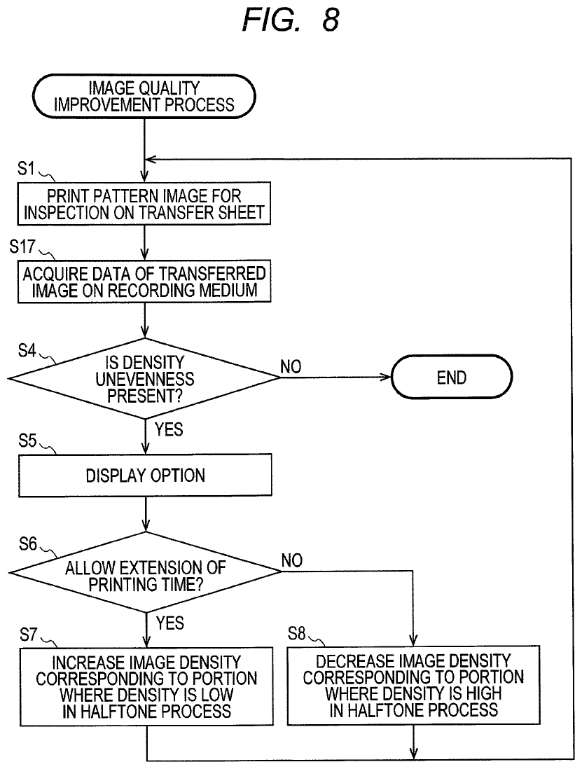

FIG. 8 is a flowchart showing an example of the operation of the printer 1 in the image quality improvement process according to the fifth embodiment. In the first embodiment, the inspection image indicating the transfer unevenness is acquired by reading the transfer sheet A after transfer by the scanner unit 14 of the printer 1. In the fifth embodiment, the inspection image indicating the transfer unevenness is acquired by capturing the recording medium with an external capturing device separate from the printer 1. Thus, in place of S2 and S3 in the flowchart of FIG. 3 described in the first embodiment, S17 is executed in FIG. 8.

More specifically, after the reversed image is formed on the transfer sheet A with sublimation ink by the control of the controller 30 (S1), the user transfers the reversed image on the transfer sheet A to the recording medium using the heat press machine as described in the first embodiment. Further, the user captures the transferred image on the recording medium by using an external capturing device to acquire data of the transferred image. The user then inputs the acquired data of the transferred image to the printer 1 via the communication interface 32. The controller 30 of the printer 1 stores the input data of the transferred image in the memory 31 as an inspection image, thereby acquiring the image data (S17).

According to the fifth embodiment, even if the printer 1 does not include the scanner unit 14, the image quality improvement process is executed. The configuration of the external capturing device is not particularly limited, and for example, a camera, a portable device having a camera function, an external scanner which is separate from the printer 1 and is connectable to the printer 1, and so on may be used.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described invention are provided below.

In the above-described embodiments, as an example, an image acquired from the transfer sheet A after transfer or an image acquired from the recording medium after transfer is used as the inspection image. However, the inspection image is not limited to this. For example, a thermal paper (thermosensitive paper) may be used instead of the transfer sheet A and the recording medium. The thermal paper is not particularly limited as long as the color of the surface changes to a degree that the color change is visually recognizable according to the surface temperature.

In a case where the thermal paper is used, in the flowchart of FIG. 3, the processing of S1 and the transfer operation to the recording medium using the heat press machine by the user are not necessary. The “transfer sheet” in S2 and S3 is replaced with “thermal paper”. The user sets a thermal paper on the heat press machine and acquires an inspection image by heating the thermal paper and capturing an image of the thermal paper after heating. The inspection image has density unevenness depending on temperature unevenness of the heating surface of the heat press machine. For example, the controller 30 extracts a portion having the highest density in the inspection image and a portion having the lowest density in the inspection image, and acquires a density difference between the two portions. If the density difference is greater than or equal to a particular value, the controller 30 determines that density unevenness is present. If the density difference is less than the particular value, the controller 30 determines that no density unevenness is present. In this way, when the thermal paper is used, since a part of the processing and the work are omitted, the image quality improvement process is simply realized.

The present disclosure is applicable to a printer that forms an image on a transfer sheet by ejecting sublimation ink, which is used in manufacturing a recording medium such as a fabric to which an image formed with sublimation ink is transferred, a storage medium storing a computer program, and a method of using the printer.

What is claimed is:

1. A printer comprising:
an ejection head including a nozzle configured to eject sublimation ink to a transfer sheet; and
a controller configured to perform:
acquiring an inspection image indicating transfer unevenness, the transfer unevenness being generated when an image on the transfer sheet is transferred to a recording medium by heat press; and
changing an image to be formed on the transfer sheet based on the inspection image.

2. The printer according to claim 1, wherein the controller is configured to control the ejection head to form a particular pattern image on the transfer sheet; and
wherein the inspection image is acquired by capturing the transfer sheet having sublimation ink remaining after the particular pattern image is transferred to the recording medium by the heat press.

3. The printer according to claim 1, further comprising an ink container mount portion configured to accommodate a plurality of ink containers, the plurality of ink containers containing sublimation ink of a plurality of colors different from each other,
wherein the controller is configured to control the ejection head to form particular pattern images for respective ones of the plurality of colors on the transfer sheet; and
wherein the inspection image is acquired by capturing the transfer sheet having sublimation ink remaining after the particular pattern images are transferred to the recording medium by the heat press.

4. The printer according to claim 1, wherein the controller is configured to perform:
reprinting, on the transfer sheet, the image changed based on the inspection image by ejecting sublimation ink; and
acquiring the image reprinted on the transfer sheet.

5. The printer according to claim 1, wherein the changing the image to be formed on the transfer sheet includes changing density of the image to be formed on the transfer sheet based on the inspection image.

6. The printer according to claim 5, wherein the changing the image to be formed on the transfer sheet includes changing a halftone process of ejecting sublimation ink onto the transfer sheet based on the inspection image.

7. The printer according to claim 6, wherein the changing the halftone process includes increasing a liquid droplet size of sublimation ink ejected from the nozzle or increasing duty of sublimation ink ejected from the nozzle.

8. The printer according to claim 6, wherein the changing the halftone process includes decreasing a liquid droplet size of sublimation ink ejected from the nozzle or decreasing duty of sublimation ink ejected from the nozzle.

9. The printer according to claim 5, wherein the changing the image to be formed on the transfer sheet includes changing color values of image data representing the image to be formed on the transfer sheet based on the inspection image, thereby increasing an image density of a portion having a low image density on the recording medium.

10. The printer according to claim 5, wherein the changing the image to be formed on the transfer sheet includes changing color values of image data representing the image to be formed on the transfer sheet based on the inspection image, thereby decreasing an image density of a portion having a high image density on the recording medium.

11. The printer according to claim 1, wherein the inspection image is an image acquired by capturing the transfer sheet having sublimation ink remaining after a particular pattern image formed on the transfer sheet is transferred to the recording medium by the heat press, or an image acquired by capturing a thermal paper heated by the heat press.

12. The printer according to claim 2, wherein the controller is configured to:
determine whether density unevenness is present in the inspection image, the density unevenness being generated due to the transfer unevenness;
in response to determining that the density unevenness is present in the inspection image, receive an input of whether to allow extension of printing time;
in response to receiving an input to allow extension of printing time, change print settings so as to increase an image density corresponding to a portion where density is low in an image on the recording medium; and
in response to receiving an input to not allow extension of printing time, change print settings so as to decrease an image density corresponding to a portion where density is high in the image on the recording medium.

13. The printer according to claim 2, wherein the controller is configured to:
control the ejection head to form, as the particular pattern image, an image having a plurality of patch images arranged in a matrix form;
extract a patch image having a highest density and a patch image having a lowest density from the plurality of patch images in a residual pattern image remaining on the transfer sheet after the particular pattern image is transferred to the recording medium;
acquire a density difference between the patch image having the highest density and the patch image having the lowest density;
determine whether the density difference is greater than or equal to a particular value;
in response to determining that the density difference is greater than or equal to the particular value, determine that density unevenness is present and change the image to be formed on the transfer sheet, the density unevenness being generated due to the transfer unevenness; and
in response to determining that the density difference is less than the particular value, determine that no density unevenness is present and not change the image to be formed on the transfer sheet.

14. The printer according to claim 3, wherein the controller is configured to:
control the ejection head to form, as one of the particular pattern images, an image having a plurality of patch images arranged in a matrix form on a first transfer sheet with sublimation ink of a first color; and
control the ejection head to form, as another one of the particular pattern images, an image having a plurality of patch images arranged in a matrix form on a second transfer sheet with sublimation ink of a second color.

15. The printer according to claim 2, further comprising an ink container mount portion configured to accommodate a plurality of ink containers, the plurality of ink containers containing sublimation ink of a plurality of colors different from each other,
wherein the controller is configured to:
control the ejection head to form, as the particular pattern image, an image having a plurality of patch images arranged in a matrix form, each of the plurality of patch images being divided into a plurality of regions, the plurality of regions being printed with sublimation ink of different colors.

16. The printer according to claim 1, wherein the inspection image is an image acquired by capturing a thermal paper heated by the heat press.

17. A non-transitory computer-readable storage medium storing a set of program instructions for a printer comprising a controller and an ejection head including a nozzle configured to eject sublimation ink to a transfer sheet, the set of program instructions, when executed by the controller, causing the printer to perform:
acquiring an inspection image indicating transfer unevenness, the transfer unevenness being generated when an image on the transfer sheet is transferred to a recording medium by heat press; and
changing an image to be formed on the transfer sheet based on the inspection image.

18. A method of using a printer including an ejection head including a nozzle configured to eject sublimation ink to a transfer sheet, the method comprising:
forming a particular pattern image by ejecting sublimation ink to the transfer sheet; and
receiving a change setting of changing an image to be formed on the transfer sheet, based on comparison between a particular color sample and either the transfer sheet having sublimation ink remaining after the pattern image on the transfer sheet is transferred to a recording medium by heat press or the recording medium having the transferred pattern image.
